(19) United States
(12) Patent Application Publication
(10) Pub. No.: US 2008/0159658 A1
(43) Pub. Date: Jul. 3, 2008

(54) Image Sensor and Method for Manufacturing The Same

(76) Inventor: YOUNG JE YUN, Ansan-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/965,180

(22) Filed: Dec. 27, 2007

(30) Foreign Application Priority Data
Dec. 27, 2006 (KR) 10-2006-0135769

(51) Int. Cl. G06K 7/10; B05D 5/06

(52) U.S. Cl. 382/321; 427/164

(57) ABSTRACT

An image sensor and a manufacturing method thereof are provided. The image sensor can include a lower layer on a substrate having a photodiode, a middle layer on the lower layer, and an upper layer on the middle layer. The middle layer can have a lower refractive index than the lower layer and the upper layer. The middle layer can also have stepped regions for filtering red, green, and blue light.

### CROSS-REFERENCE TO RELATED APPLICATION

The present application claims the benefit under 35 U.S.C. §119 of Korean Patent Application No. 10-2006-0135769, filed Dec. 27, 2006, which is hereby incorporated by reference in its entirety.

### BACKGROUND

Image sensors are semiconductor devices that convert optical images to electrical signals and can be classified as charge coupled device (CCD) or complementary metal oxide semiconductor (CMOS) image sensors.

CMOS image sensors include a photodiode and MOS transistors in a unit pixel. CMOS image sensors sequentially detect electrical signals in a switching manner to realize an image.

The process of forming a color filter is one of the most important processes influencing image sensor performance. In the related art, a color filter array is typically formed on the uppermost layer of the device using a photoresist layer as the color filter before forming microlenses.

According to the typical related art method, however, optical efficiency is lowered when light passing through the color filter array reaches a photodiode because the total thickness of the device is unnecessarily increased due to the photoresist layer of the color filter array.

In addition, according to the related art, color separation capability is limited due to a limitation in filtering efficiency of the photoresist layer that filters red, green, and blue signals as a band-pass filter.

Thus, there exists a need in the art for an improved image sensor and fabricating method thereof.

### BRIEF SUMMARY

Embodiments of the present invention provide an image sensor and manufacturing method thereof The image sensor can have better color separation capability than a related art color filter.

An image sensor according to the present invention can also be significantly thinner than a related art image sensor.

In an embodiment, an image sensor can include a lower layer on a substrate including a photodiode, a middle layer on the lower layer, and an upper layer on the middle layer. The middle layer can have a lower refractive index than the lower layer and the upper layer. The middle layer can also have red, green, and blue regions with different thicknesses.

In another embodiment, a method for manufacturing an image sensor can include: forming a lower layer on a substrate including a photodiode; forming a middle layer on the lower layer, wherein the middle layer has a lower refractive index than the lower layer; and forming an upper layer on the middle layer, wherein the upper layer has a higher refractive index than the middle layer. The middle layer can also have red, green, and blue regions with different thicknesses.

The details of one or more embodiments are set forth in the accompanying drawings and the detailed description below. Other features will be apparent to one skilled in the art from the detailed description, the drawings, and the appended claims.

### BRIEF DESCRIPTION OF THE DRAWINGS

FIG. 1 is a cross-sectional view of an image sensor according to an embodiment of the present invention.

FIGS. 2 to 6 are cross-sectional views illustrating a method for manufacturing an image sensor according to an embodiment of the present invention.

### DETAILED DESCRIPTION

When the terms “on” or “over” are used herein, when referring to layers, regions, patterns, or structures, it is understood that the layer, region, pattern or structure can be directly on another layer or structure, or intervening layers, regions, patterns, or structures may also be present. When the terms “under” or “below” are used herein, when referring to layers, regions, patterns, or structures, it is understood that the layer, region, pattern or structure can be directly under the other layer or structure, or intervening layers, regions, patterns, or structures may also be present.

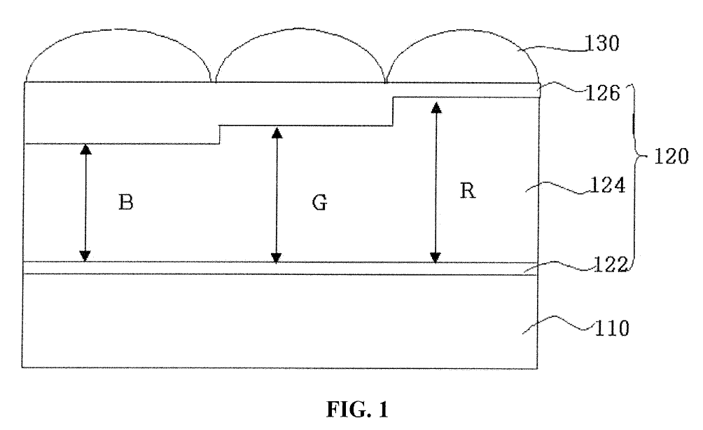

Referring to FIG. 1, in an embodiment, an image sensor can include a lower layer 122, a middle layer 124 disposed on the lower layer 122, an upper layer 126 disposed on the middle layer 124, and microlenses 130 disposed on the tipper layer 126. Here, the lower layer 122 can be disposed on a substrate 110 having a photodiode (not shown). The middle layer 124 can have a lower refractive index than the lower layer 122. The middle layer 124 can also have red (R), green (G), and blue (B) regions with different thicknesses. In addition, the upper layer 126 can have a higher refractive index than the middle layer 124.

An image sensor according to an embodiment can include an interference filter 120 made up of the lower layer 122, the middle layer 124, and the upper layer 126. The interference filter 120 can have stepped portions in the R, G, and B regions such that each of the R, G, and B regions has a different thickness. The interference filter 120 with stepped portions in the R, G, and B regions can be used to replace a related art color filter in an image sensor and exhibit better color separation capability.

In an embodiment, the red (R) region can have a thickness that is about the same as the maximum thickness of the middle layer 124, the green (G) region can have a thickness that is smaller than that of the red (R) region, and the blue (B) region can have a thickness that is smaller than that of the green (G) region.

The image sensor according to an embodiment of the present invention can use the principle of a Fabry-Perot interference filter.

According to the principle of a Fabry-Perot interference filter, light passing through a filter is only light of λ₁, even though light of multiple wavelengths, such as λ₁+λ₂+λ₃ may be present in incident light, where λ denotes a wavelength.

The wavelength of light which can pass through the filter can be calculated from the following equation: 2nt×cos θ=mλ, where n is the refractive index, t is the thickness of the filter, θ is the angle of the light, m is the order of interference, and λ is the wavelength of the light. If the light is vertically incident, θ is 0, which gives cos θ=1. Assuming a common case where m=1, the equation can be expressed as 2nt=λ. Thus, a thickness required for light to be transmitted can be calculated from t=λ/(2n).

In an image sensor having the above structure, the interference filter 120 can be used as a color filter. Thus, the overall thickness of the image sensor can be less than that of a related art image sensor.

The image sensor of an embodiment of the present invention can also keep optical efficiency high for light passing through the microlenses to an underlying photodiode.

Furthermore, the image sensor of an embodiment of the present invention can allow for precise color separation due to precise band-pass filtering.

A related art color filter array generally has a thickness of about 1.500 nm, but the image sensor according to the present invention can reduce the thickness of a color filter by employing the interference filter 120.

The optical properties of the material of the middle layer 124 of the interference filter 120 according to embodiments of the present invention are: the material is transparent; the material has an imaginary refractive index (k) of about 0.05 or less in a visible light region; and the material has a real refractive index (n) lower than that of the lower layer 122 and that of the upper layer 126.

The middle layer 124 can include any suitable material known in the art, for example, an oxide. The middle layer 124 can have a refractive index (n) of, for example about 1.4 to about 1.5 in a visible light region. This is less than the refractive index (n) of a typical photoresist layer, which is in the range of about 1.7 to about 1.8. In an embodiment, the middle layer 124 can include tetraethyl orthosilicate (TEOS).

As described above, the thickness of a region in the middle layer 124 (t=λ/(2n)) can be determined depending on the wavelength of light.

Generally, the wavelength of red light is in the range of about 610 nm to about 700 nm, the wavelength of green light is in the range of about 500 nm to about 570 nm, and the wavelength of blue light is in the range of about 450 nm to about 500 nm.

For example, the material used for the middle layer 124 can have a refractive index (n) of about 1.4. In such an embodiment, the red (R) region of the middle layer 124 can have a thickness of about 290 nm to about 340 nm.

In one embodiment, the red (R) region of the middle layer 124 can have a thickness of about 293 nm to about 337 nm.

The green (G) region of the middle layer 124 can have a thickness of about 230 nm to about 280 nm. In one embodiment the green (G) region of the middle layer 124 can have a thickness of about 240 nm to about 274 nm.

The blue (B) region of the middle layer 124 can have a thickness of about 210 nm to about 250 nm. In one embodiment, the blue (B) region of the middle layer 124 can have a thickness of about 216 nm to about 240 nm.

The lower layer 122 can include any suitable material known in the art, for example, a nitride layer having a refractive index (n) of about 2.2 to about 2.3. In an embodiment, the lower layer 122 can include silicon nitride (SiN). Additionally, the upper layer 126 can include any suitable material known in the art, for example, a nitride layer having a refractive index (n) of about 2.2 to about 2.3. In an embodiment, the upper layer 126 can include silicon nitride (SiN).

Accordingly, in an embodiment of the present invention, a Fabry-Perot interference filter 120 can be provided in each pixel. The interference filter 120 can serve as a color filter, in place of a related art color filter array typically formed of a photoresist. Furthermore, the image sensor according to an embodiment can exhibit better color separation capability due to the interference filter 120 having R, G, and B portions of different thicknesses.

Moreover, according to an embodiment, the image sensor can be thinner than a related art image sensor since a typical color filter array can be omitted. Thus, the amount of light reaching a photodiode can be increased, and the optical efficiency of the image sensor can be improved.

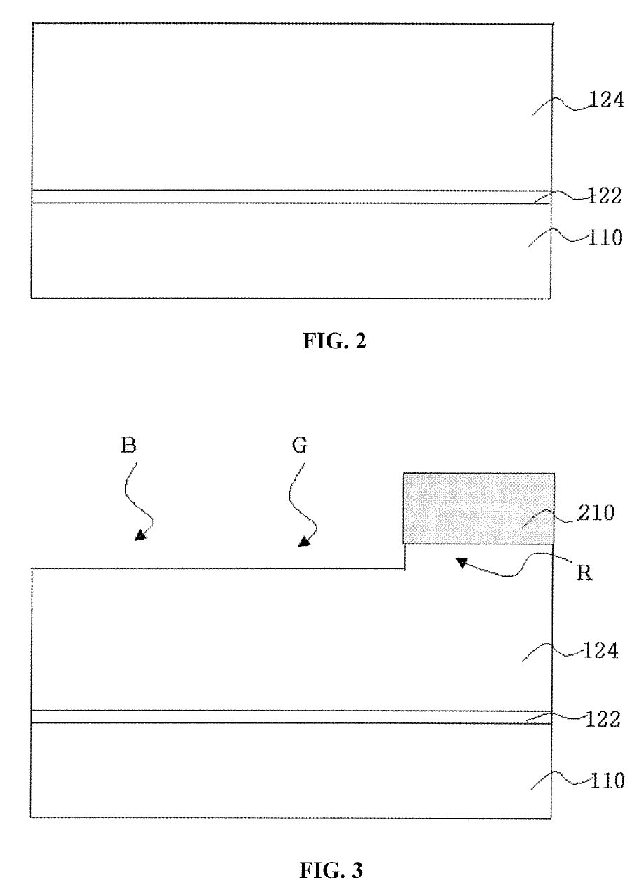

FIGS. 2 to 6 are cross-sectional views illustrating a method for manufacturing an image sensor according to an embodiment of the present invention.

Referring to FIG. 2, a lower layer 122 can be formed on a substrate 110 having a photodiode (not shown). The lower layer 122 can be formed of any suitable material known in the art, for example, a nitride having a refractive index (n) of about 2.2 to about 2.3. In an embodiment, the lower layer 122 can be formed of SiN.

Then, a middle layer 124 can be formed on the lower layer 122. R, G, and B regions can be defined on the middle layer 124. The middle layer 124 can be formed of any suitable material known in the art, for example, an oxide having a refractive index (n) of about 1.4 to about 1.5 in a visible light region. In one embodiment, the middle layer 124 can be formed of TEOS.

In an embodiment, the middle layer 124 can be formed to a maximum thickness of about 290 nm to about 340 nm.

Referring to FIG. 3, a first photoresist pattern 210 can formed on the middle layer 124 over a region defined for the R region. Then, the middle layer 124 can be etched to a first depth using the first photoresist pattern 210 as an etch mask.

The etching of the middle layer 124 to the first depth can be performed such that the etched middle layer 124 in the G and B regions can have an initial etched thickness of about 230 nm to about 280 nm.

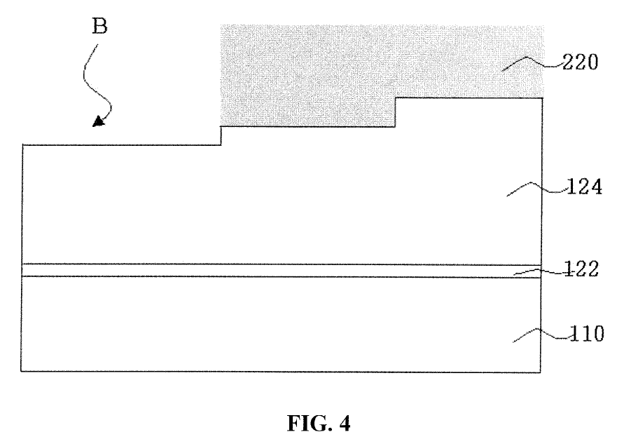

Referring to FIG. 4, the first photoresist pattern 210 can be removed, and a second photoresist pattern 220 can be formed on the etched middle layer 124 over the R and G regions such that the B region is exposed.

Then, the B region of the middle layer 124 can be etched to a second depth using the second photoresist pattern 220 as an etch mask.

The etching of the B region of the middle layer 124 to the second depth can be performed such that the etched middle layer in the B region can have a thickness of about 210 nm to about 250 nm.

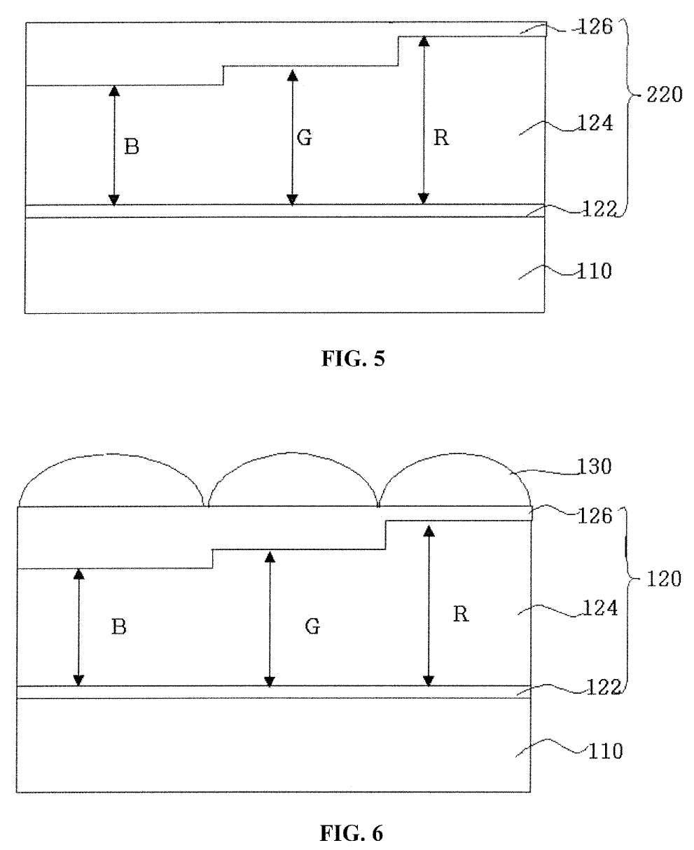

Referring to FIG. 5, an upper layer 126 can be formed on the twice-etched middle layer 124. The upper layer 126 can be formed of any suitable material known in the art, for example, a nitride having a refractive index (n) of about 2.2 to about 2.3. In an embodiment, the upper layer 126 can be formed of SiN.

In an embodiment, a planarization process can be performed on the upper layer 126, for example, a chemical mechanical polishing (CMP) process or an etch-back process.

Accordingly, an interference filter 120 can include the lower layer 122, the middle layer 124, and the upper layer 126. In the middle layer 124, the R region can be have a thickness that is about the same as the maximum thickness of the middle layer 124, the G region can have a thickness that is less than that of the R region, and the B region can have a thickness that is less than that of the G region.

Accordingly, in an embodiment of the present invention, a Fabry-Perot interference filter 120 can be provided in each pixel. The interference filter 120 can serve as a color filter, in place of a related art color filter array typically formed of a photoresist. Furthermore, the image sensor according to an embodiment can exhibit better color separation capability due to the interference filter 120 having R, G, and B portions of different thicknesses.

Moreover, according to an embodiment, the image sensor can be thinner than a related art image sensor since a typical color filter array can be omitted. Thus, the amount of light reaching a photodiode can be increased, and the optical efficiency of the image sensor can be improved.

Referring to FIG. 6, microlenses 130 can be formed on the upper layer 126.

In embodiments of the present invention, an interference filter can be formed such that it has stepped portions and can replace a related art color filter and exhibit improved color separation capability.

Furthermore, according to embodiments of the present invention, the image sensor can be thinner than a related art image sensor since a typical color filter array can be omitted. Thus, the amount of light reaching a photodiode can be increased, and the optical efficiency of the image sensor can be improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image sensor, comprising:
a lower layer on a substrate including a photodiode;
a middle layer on the lower layer, wherein a refractive index of the middle layer is lower than a refractive index of the lower layer; and
an upper layer on the middle layer, wherein a refractive index of the upper layer is higher than the refractive index of the middle layer;
wherein the middle layer comprises a red region, a green region, and a blue region; and wherein a thickness of the red region is different than a thickness of the green region and a thickness of the blue region; and wherein the thickness of the green region is different than the thickness of the blue region.

2. The image sensor according to claim 1, wherein the middle layer comprises a transparent material, and wherein the transparent material has an imaginary refractive index of about 0.00 to about 0.05 in a visible light region.

3. The image sensor according to claim 1, wherein the middle layer has a refractive index of about 1.4 to about 1.5.

4. The image sensor according to claim 1, wherein the thickness of the red region of the middle layer is about the same as a maximum thickness of the middle region, and wherein the thickness of the green region of the middle layer is less than the thickness of the red region of the middle layer, and wherein the thickness of the blue region of the middle layer is less than the thickness of the green region of the middle layer.

5. The image sensor according to claim 1, wherein the middle layer comprises an oxide.

6. The image sensor according to claim 1, wherein the middle layer comprises TEOS.

7. The image sensor according to claim 1, wherein the thickness of the red region of the middle layer is about 290 nm to about 340.

8. The image sensor according to claim 1, wherein the thickness of the green region of the middle layer is about 230 nm to about 280 nm.

9. The image sensor according to claim 1, wherein the thickness of the blue region of the middle layer is about 210 nm to about 250 nm.

10. The image sensor according to claim 1, wherein the upper layer comprises a nitride that has a refractive index of about 2.2 to about 2.3.

11. The image sensor according to claim 1, wherein the lower layer comprises a nitride that has a refractive index of about 2.2 to about 2.3.

12. A method for manufacturing an image sensor, comprising:
forming a lower layer on a substrate including a photodiode;
forming a middle layer on the lower layer, wherein a refractive index of the middle layer is lower than a refractive index of the lower layer; and
forming an upper layer on the middle layer, wherein a refractive index of the upper layer is higher than the refractive index of the middle layer;
wherein the middle layer comprises a red region, a green region, and a blue region; and wherein a thickness of the red region is different than a thickness of the green region and a thickness of the blue region; and wherein the thickness of the green region is different than the thickness of the blue region.

13. The method according to claim 12, further comprising forming a microlens on the upper layer.

14. The method according to claim 12, wherein forming the middle layer comprises:
forming the middle layer on the lower layer, wherein the red region, the green region, and the blue region are defined in the middle layer;
forming a first photoresist pattern on the red region of the middle layer:
etching the middle layer to a first depth using the first photoresist pattern as an etch mask;
forming a second photoresist pattern on the red region and the green region of the middle layer; and
etching the middle layer to a second depth using the second photoresist pattern as an etch mask.

15. The method according to claim 14, wherein forming the middle layer on the lower layer where the red region, the green region, and the blue region are defined comprises forming the middle layer to a thickness of about 290 nm to about 340 nm.

16. The method according to claim 14, wherein etching the middle layer to the first depth comprises etching the green region and the blue region of the middle layer until the thickness of the green region of the middle layer and the thickness of the blue region of the middle layer is about 230 nm to about 280 nm.

17. The method according to claim 14, wherein etching the middle layer to the second depth comprises etching the blue region of the middle layer until the thickness of the blue region is about 210 nm to about 250 nm.

18. The method according to claim 12, further comprising planarizing the upper layer after forming the upper layer.

19. The method according to claim 12, wherein the middle layer comprises a transparent material, and wherein the transparent material has an imaginary refractive index of about 0.00 to about 0.05 in a visible light region.

20. The method according to claim 12, wherein the middle layer has a refractive index of about 1.4 to about 1.5.
